(19) United States
(12) Patent Application Publication
(10) Pub. No.: US 2013/0138938 A1
(43) Pub. Date: May 30, 2013

(54) METHOD, RECORDING MEDIUM, AND ELECTRONIC DEVICE FOR REDUCING BOOT TIME

(71) Applicants: Yousok BANG, Seoul (KR); Jonghwa SHIN, Seoul (KR)

(72) Inventors: Yousok BANG, Seoul (KR); Jonghwa SHIN, Seoul (KR)

(73) Assignee: LG ELECTRONICS INC., Seoul (KR)

(21) Appl. No.: 13/330,267

(22) Filed: Dec. 19, 2011

Related U.S. Application Data
(60) Provisional application No. 61/564,254, filed on Nov. 28, 2011.

(51) Int. Cl. G06F 9/00

(52) U.S. Cl. 713/2

(57) ABSTRACT

The present invention relates to a method of reducing the boot time of an electronic device (i.e., improving the boot speed of the electronic device), such as a computer, an electronic device to which the method is applied, and a recording medium on which the method is recorded. There is provided a method of booting an electronic device includes hiding at least one first device of devices, included in the electronic device, through an initial start-up program, loading drivers corresponding to remaining devices other than the at least one first device, from among the included devices, by driving an Operating System (OS) of the electronic device, and unhiding the hidden at least one first device through the initial start-up program according to a predetermined event.

This nonprovisional application claims the benefit of U.S. Provisional Application 61/564,254 filed on Nov. 28, 2011, which is hereby expressly incorporated by reference into the present application.

### BACKGROUND

1. Field

The present invention relates to a method of reducing the boot time of an electronic device, a recording medium on which the method is recorded, and an electronic device to which the method is applied.

2. Related Art

When the supply of power is started, a computer starts a start-up process. In most cases, the initial step of the start-up process is started by firmware stored in memory, such as the Read Only Memory (ROM) of the computer, which is called a Basic Input Output System (BIOS). According to the operation of the BIOS, various lower devices included in the computer are prepared for an available state. The BIOS transfers information about devices, connected to the computer, to an Operating System (OS) so that the OS can normally govern the operations of the computer.

In the start-up process of the computer, the OS loads drivers, corresponding to various devices included in the computer, into the memory so that the various devices can be properly controlled in response to a user's input/command. Accordingly, the computer enters a preparation state for being operated as the user wants. While the preparation step of the computer is performed (in particular, when the preparation state is almost completed), the OS outputs a basic screen (e.g., a wallpaper of the Windows OS by Microsoft Corporation) for enabling a user to normally use the computer to a display module included in or connected to the computer, such as a monitor.

The user may not perform a series of operations for using the computer, such as performing specific input to the computer or issuing a specific command to the computer until the basic screen is displayed after turning ‘on’ the power button of the computer in order to use the computer. For this reason, the user considers the time taken for the basic screen of the OS to be displayed after power is turned on as a ‘boot time’.

Since all the devices included in the computer are made the preparation state until the basic screen is displayed as described above, however, the boot time taken for the devices is inevitably increased according to an increase in the number of devices.

Meanwhile, there is a tendency that a user wants a computer to include more devices and to have a stronger computing ability and also wants the computer to have a faster boot speed. For this reason, there is an urgent need for the development of technology with an improved boot speed although more devices are included in the computer.

### SUMMARY

It is an object of the present invention to provide a method of reducing the boot time of an electronic device (i.e., for improving the boot speed of the electronic device), such as a computer, an electronic device to which the method is applied, and a recording medium on which the method is recorded.

According to an aspect of the present invention, there is provided a method of booting an electronic device, including hiding at least one first device of devices, included in the electronic device, through an initial start-up program; loading drivers corresponding to the remaining devices other than the at least one first device, from among the included devices, by driving an Operating System (OS) of the electronic device; and unhiding the hidden at least one first device through the initial start-up program according to a predetermined event.

After the at least one first device is unhidden, loading a driver corresponding to the at least one first device may be further performed through the OS.

Loading the driver corresponding to the at least one first device may be executed or completed after a basic screen for user input provided by the OS is displayed.

Hiding the at least one first device may include at least one of blocking the supply of power to the at least one first device, blocking the supply of a clock to the at least one first device, maintaining the at least one first device in a reset state, and distorting information about the at least one first device and transferring the distorted information to the OS.

Unhiding the hidden at least one first device may include at least one of starting the supply of the power to the at least one first device, starting the supply of the clock to the at least one first device, preparing the at least one first device in a standby state or a reset clear state, and transferring the information about the at least one first device to the OS.

The predetermined event may include at least one of the loading of a predetermined service or a predetermined script or both through the OS, the generation of a logon event through the OS, an elapse of a predetermined time, and the generation of access to the at least one first device.

The OS may do not search for the at least one first device until the at least one first device is unhidden.

According to another aspect of the present invention, there is provided an electronic device, including a plurality of devices; first memory for storing an initial start-up program; second memory for storing an Operating System (OS); and a controller for hiding at least one first device of the plurality of devices through the initial start-up program, loading drivers corresponding to remaining devices other than the at least one first device, from among the plurality of devices, by driving the OS, and unhiding the hidden at least one first device through the initial start-up program according to a predetermined event.

The controller may load a driver corresponding to the at least one first device through the OS, after the at least one first device is unhidden. Furthermore, the controller may load the driver corresponding to the at least one first device so that the loading of the driver corresponding to the at least one first device is finished, after a basic screen for user input provided by the OS is displayed.

Meanwhile, the controller may hide the at least one first device by performing at least one of blocking the supply of power to the at least one first device, blocking the supply of a clock to the at least one first device, maintaining the at least one first device in a reset state, and distorting information about the at least one first device and transferring the distorted information to the OS.

The controller may unhide the at least one first device by performing at least one of starting the supply of the power to the at least one first device, starting the supply of the clock to the at least one first device, preparing the at least one first device in a standby state, and transferring the information about the at least one first device to the OS.

The predetermined event may include at least one of the loading of a predetermined service or a predetermined script or both through the OS, the generation of a logon event through the OS, an elapse of a predetermined time, and the generation of access to the at least one first device.

The OS may do not search for the at least one first device until the at least one first device is unhidden.

According to yet another aspect of the present invention, there is provided a recording medium on which an initial start-up program for executing a method of hiding at least one first device, selected from among a plurality of devices included in an electronic device, and of an Operating System (OS) of the electronic device loading drivers corresponding to the remaining devices other than the at least one first device, from among the plurality of devices, and unhiding the hidden at least one first device through the initial start-up program according to a predetermined event is recorded.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a schematic diagram illustrating the configuration of an electronic device related to some embodiments of the present invention;

FIG. 2 is a diagram illustrating a first embodiment of a method of reducing the boot time of an electronic device according to an aspect of the present invention;

FIG. 3 is a diagram illustrating a second embodiment of a method of reducing the boot time of an electronic device according to an aspect of the present invention; and

FIG. 4 is a diagram illustrating a third embodiment of a method of reducing the boot time of an electronic device according to an aspect of the present invention.

### DETAILED DESCRIPTION OF THE EMBODIMENTS

Hereinafter, embodiments of the present invention will be described in detail with reference to the accompanying drawings so that they can be readily implemented by those skilled in the art.

The above object, characteristics, and merits of the present invention will become more apparent from the following detailed description taken in conjunction with the accompanying drawings. The present invention may be modified in various ways and may have some embodiments. Hereinafter, some exemplary embodiments of the present invention will be illustrated in the accompanying drawings and described in detail. The same reference numerals basically designate the same elements throughout the drawings. Furthermore, a detailed description of the known functions or elements pertinent to the present invention will be omitted if it is deemed to make the gist of this document unnecessarily vague. Numbers (for example, first and second) used in a process of describing this specification are merely identification symbols for distinguishing one element from the other element.

An electronic device related to the present invention is described in detail below with reference to the accompanying drawings. It is to be noted that the suffixes of elements used in the following description, such as “module” and “unit,” are assigned or mixed in use by taking only the easiness of writing this specification into consideration, but in itself are not particularly given importance and roles.

An electronic device described in this specification may include a computer, such as a Personal Computer (PC), a mobile phone, a smart phone, a laptop computer, a terminal for digital broadcasting, a Personal Digital Assistant (PDA), a Portable Multimedia Player (PMP), and a navigator. However, those skilled in the art will easily understand that constructions according to the embodiments written in this specification may also be applied to other forms of electronic devices other than a case where the constructions are applicable to the electronic device of the present invention.

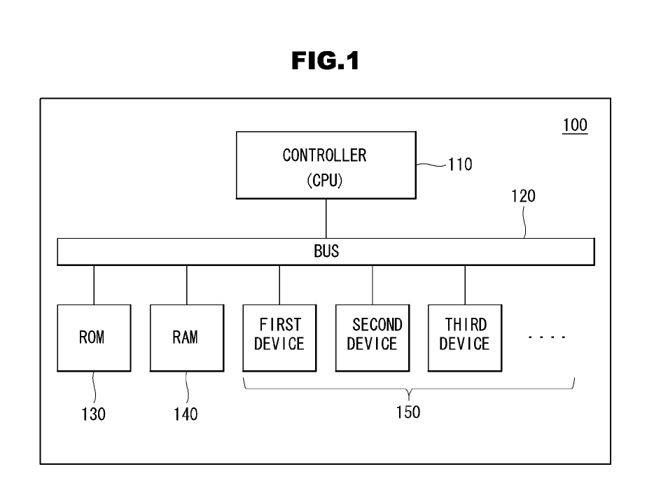

FIG. 1 is a schematic diagram illustrating the configuration of an electronic device related to some embodiments of the present invention.

As shown in FIG. 1, the electronic device 100 may include a controller 110, a bus 120, Read Only Memory (ROM) 130, Random Access Memory (RAM) 140, and various types of devices 150.

The controller 110 is a device commonly called a Central Processing Unit (hereinafter referred to as a ‘CPU’). The CPU 110 is the main control means of the electronic device and configured to perform overall control on the electronic device, such as the interpretation of a command, the operation of data, and comparison.

The bus 120 is a hardware module or a software module or both which is commonly called a system bus and is means for connecting the ROM 130, the RAM 140, and the devices 150 to the CPU 110. For example, the bus 120 may include a northbridge for connecting the elements of the electronic device, requiring a fast transmission speed and high system performance, to the CPU 110 and a southbridge for connecting the elements of the electronic device, requiring a relatively slow transmission speed and relatively low system performance, to the CPU 110. The CPU 110 can receive various data from the ROM 130, the RAM 140, and the devices 150 and transmit the results of interpretation, operation, and comparison of the received data to the ROM 130, the RAM 140, and the devices 150, through the bus 120.

The ROM 130 is an information storage device formed of non-volatile memory means, such as flash memory, and firmware or software, such as a Basic Input Output System (BIOS), may be stored in the ROM 130. The ROM 130 is formed of non-volatile memory and thus is configured to store pieces of information that must be retained although power is not supplied to the electronic device 100. In general, the ROM 130 is connected to the southbridge.

The RAM 140 is a device commonly called a main storage device. The ROM 140 may store data, such as an OS necessary for the electronic device to perform tasks, data, such as programs being enabled, or data to be operated, or all of them. In general, the RAM 140 is connected to the northbridge.

The plurality of devices 150 refers to modules that are included in the electronic device 100 or connected to the electronic device 100 and are configured to perform various functions. The devices 150 may include interface modules for performing functions of providing an interface between the devices 150 and the CPU 110 and function execution modules that are connected to the interface modules and configured to perform functions specific to the interface modules.

The interface modules may include, for example, modules operated by various interface modules, such as a Peripheral Component Interconnect (PCI) bus, Integrated Drive Electronics (IDE), Serial Advanced Technology Attachment (SATA), a Universal Serial Bus (USB), a High Definition Multimedia Interface (HDMI), a Small Computer System Interface (SCSI), and an Intel Management Interface controller.

The function execution modules may include, for example, various pieces of hardware or various pieces of software or both, such as a video controller (e.g., a graphic card), a modem, an audio controller (e.g., an audio card), a camera (e.g., a web cam), a hard disk, a Bluetooth module, and a Wi-Fi module.

In order to help understand the present invention, the common boot sequence of the electronic device 100 is briefly described below.

When power is supplied (e.g., when a user turns on a power switch), the electronic device 100 may detect the various devices 150 connected thereto and determine whether the various devices 150 are normally operated by performing the operations of the BIOS stored in the ROM 130. For example, the BIOS may detect the devices 150 and determine whether the various devices 150 are normally operated by performing a series of diagnosis test processes called a Power On Self Test (POST). Here, the BIOS may supply power to each of the devices 150. The BIOS may also perform an operation of initializing each of the devices 150 in hardware so that the device can be normally operated. For example, in order to initialize each device 150 in hardware, the BIOS may make the device a standby state by clearing the reset of the device and also start supplying a clock necessary to drive the system.

After the BIOS normally initializes each device as described above, an Operating System (OS) stored in an auxiliary storage device, such as a hard disk, may be fetched and loaded into the RAM 140. At this time, the BIOS may provide the OS with information about each of the devices included in or connected to the electronic device 100.

Next, the OS may initialize each of the devices, included in or connected to the electronic device 100, in software. The software initialization of the devices may be performed by loading drivers necessary to control the respective devices into the RAM 140, etc.

Furthermore, the OS may perform various stages (e.g., operations, such as the execution of various services or various scripts or both necessary to operate the electronic device 100) necessary to normally operate the electronic device 100 in addition to the tasks for loading the drivers. When the electronic device 100 is prepared to be used, the OS may display a basic screen, provided so that a user can normally input data or commands or both to the electronic device 100, through a display device, such as a monitor, thus completing the booting process.

A first embodiment of a method of reducing the boot time of the electronic device 100 according to an aspect of the present invention which may be applied to the electronic device 100 is described in detail below. It is to be noted that although the method of reducing the boot time of the electronic device 100 of FIG. 1 according to an aspect of the present invention is described by taking the electronic device 100 as an example, for convenience of description, the method is not necessarily limited to the electronic device 100 described with reference to FIG. 1.

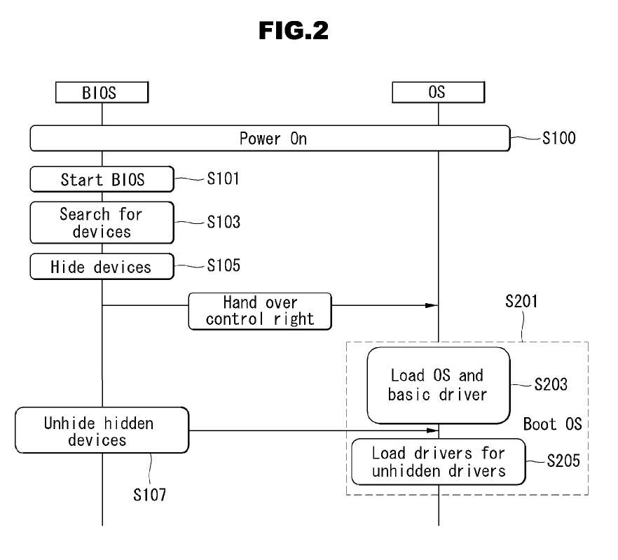

FIG. 2 is a diagram illustrating the first embodiment of the method of reducing the boot time of the electronic device 100 according to the aspect of the present invention.

Referring to FIG. 2, power may start being supplied to the electronic device 100 at step S100. For example, power may start being supplied to the electronic device 100 through an operation, such as an action in which a user presses a power button included in the electronic device 100.

Next, the electronic device 100 may start the BIOS at step S101. When power starts being supplied, the operations of the electronic device 100 may be controlled by the BIOS stored in the ROM 130.

At this time, the BIOS may search for the various devices 150 included in or connected to the electronic device 100 as described above at step S103.

Next, the BIOS may hide some selected devices of the retrieved devices 150 at step S105. The devices hidden at step S105, from among the devices 150 included in or connected to the electronic device 100, are hereinafter called first devices and the remaining devices not hidden are called second devices, for convenience of description. A method of hiding the first devices selected by the BIOS will be described in detail later.

The devices hidden at step S105 may include a PCI, a USB, and HDMI, a modem, SATA, etc., but not necessarily limited thereto. Some of the illustrated devices may not be hidden, and other devices not illustrated may be hidden.

After the first devices are hidden, an OS is loaded into the electronic device 100 at step S203, and thus the control right of the electronic device 100 is handed over from the BIOS to the OS. At step S203, drivers for the second devices may be loaded by the OS, and thus the second devices become a preparation state for normal operations. In general, in order to upload the drivers for the respective devices included in the electronic device 100, the OS may search for the devices included in the electronic device 100 or receive information about the devices from the BIOS. The OS loads the drivers for the devices on the basis of the retrieved results or the information received from the BIOS or both. In the method of reducing the boot time of the electronic device according to the first embodiment of the present invention, however, since the BIOS intentionally hides the first devices, the OS loads only drives for the remaining devices other than the hidden first devices.

While the step S203 is performed or after the step S203 is performed, the BIOS may unhide the hidden first devices when a predetermined event is generated at step S107. A method of the BIOS unhiding the hidden first devices and types of the predetermined events will be described in detail later. Accordingly, the OS may load drivers corresponding to the unhidden first devices at step S205.

Although not shown, before the step S205 is performed or while the step S205 is performed, the OS outputs a basic screen (e.g., a wallpaper provided by the Windows OS of Microsoft Corporation), and the user can normally use the electronic device 100 for the first time.

The method of reducing the boot time of the electronic device according to the first embodiment of the present invention has been described above with reference to FIG. 2. The hiding of the devices and the unhiding of the devices are described in more detail below.

The hiding step S105 of the devices is first described below.

The hiding of the devices is performed on only some selected from among the devices 150 included in the electronic device 100.

A method of selecting the first devices (i.e., devices to be hidden) may be various. The simplest method is a method of maintaining a list of devices other than devices (i.e., the second devices) positively necessary for the booting operation and selecting the devices, belonging to the list, as the first devices.

The devices positively necessary for the booting operation refer to devices in which the loading of an OS is impossible or several stages included in the boot sequence of the OS cannot be normally performed, if the devices are not normally operated. The devices positively necessary for the booting operation may typically include a device, such as an auxiliary storage device in which an OS is stored.

The list may be set as a basic value, but may be modified by a user. For example, a list of the first devices (or a list of the second devices) may be modified by the setting of a user through a user interface, such as the setting screen of the BIOS.

The device hiding (S105) operation is performed on the first devices selected according to the above method. The hiding of the devices may be performed by a power control method, a reset control method, a clock control method, and an information distortion method. Each of the device hiding methods is described in detail below.

The power control method refers to a method of hiding devices according to a method of intentionally blocking power supplied to the devices. The BIOS may intentionally block the supply of power to the first devices, selected according to the above method, so that the first devices cannot be normally operated. Here, the supply of power to the first devices may be blocked when power is first supplied at step S100, but may preferably be blocked after the BIOS searches for devices at step S103.

The reset control method refers to a method of hiding devices according to a method in which the BIOS continues to maintain the devices in a reset state instead of preparing the devices for a standby state. The BIOS may intentionally maintain the selected first devices in the reset state so that the first devices cannot be normally operated. In this case, the OS cannot search for the first devices because the first devices maintain the reset state although power is normally supplied to the first devices. Accordingly, the first devices can be hidden for the OS.

The clock control method refers to a method of hiding devices according to a method in which the BIOS does not supply a clock. The BIOS may not intentionally supply a clock, positively necessary for the operation of each device, to the selected first devices so that the first devices cannot be normally operated. In this case, the OS cannot search for the first devices because a clock is not supplied to the first devices and thus the first devices cannot be normally operated although power is normally supplied to the first devices. Accordingly, the first devices can be hidden for the OS.

Finally, the information distortion method refers to a method in which the BIOS provides an OS with false information so that the OS cannot normally search for devices. In general, the BIOS provides the OS with information about devices retrieved as the result of performing the step S103, and the OS searches for the device, included in the electronic device 100, based on the received information. If the BIOS intentionally excludes information about the selected first devices from the information about the retrieved devices and provides the information about the selected first devices to the OS, the first devices can be hidden for the OS because the OS cannot search for the first devices. In this case, although power and a clock are normally supplied to the selected first devices and the BIOS prepares the selected first devices in a standby state, the first devices can be hidden because the OS cannot normally scan the first devices.

The hiding of the devices may be performed by using any one of the four kinds of methods as described above, but may be performed by a combination of two or more of the four kinds of methods.

Meanwhile, in the method of reducing the boot time of an electronic device according to the first embodiment of the present invention, the device hiding operation may be performed by any one of various methods, but the object of device hiding is to prevent an OS from normally detecting devices included in or connected to the electronic device 100. It is preferred that, in either case, the device hiding operation be performed before the bus 120 is scanned in order to search for the devices included in or connected to the electronic device 100. That is, if the OS starts scanning the bus at the request of the BIOS, it will be preferred that even after the OS is loaded, the BIOS perform the device hiding operation before the BIOS requests the OS to scan the bus. If the bus 120 is automatically scanned when the OS is loaded, it will be preferred that the BIOS perform the device hiding operation before the OS is loaded.

The various device hiding methods according to the first embodiment of the present invention have been described above. The subject of device hiding is described in more detail below.

In accordance with the device hiding operation according to the first embodiment of the present invention, the first devices included in the electronic device 100 or connected to the electronic device 100 may be hidden, or some selected from among plurality of channels provided by the first devices may be hidden.

For example, assuming that the first devices are USB devices, all the USB devices may be hidden by hiding a USB controller for controlling the USB devices. Accordingly, modules or all the external devices or both that are included in or connected to the electronic device 100 through the USB devices can be hidden for an OS.

Meanwhile, the USB controller in itself may not be hidden, but specific modules or specific electronic devices connected to the USB devices may not be hidden. For example, external devices connected to the USB devices, such as the keyboard or the mouse, may not be hidden.

As described above, a range of devices to be hidden can be freely designated according to the first embodiment of the present invention. Accordingly, the electronic device according to the first embodiment of the present invention may be configured so that it satisfies more various user preferences or more various user needs or both.

The device unhiding operation (S107) may be performed by performing an operation opposite to the device hiding operation (S105).

For example, if the device hiding operation has been performed according to the information distortion method, the device unhiding operation may be performed by again supplying an OS with information about devices into which actual information not distorted is incorporated.

For another example, if the device hiding operation has been performed according to the clock control method, the device unhiding operation may be performed by supplying a clock to relevant devices.

For yet another example, if the device hiding operation has been performed according to the reset control method, the device unhiding operation may be performed by switching relevant devices from a reset state to a standby state.

For still yet another example, if the device hiding operation has been performed according to the power control method, the device unhiding operation may be performed by supplying power to relevant devices. If devices have been hidden according to the power control method, the devices can be normally unhidden only when a reset is released and a clock starts being supplied after power is supplied.

As described above, the device unhiding method may be determined depending on the device hiding method. Accordingly, if devices have been hidden by a combination of two or more of the four kinds of methods, the devices can be unhidden by a combination of two or more of the four kinds of methods, corresponding to the two or more methods used to hide the devices. For example, if devices have been hidden by a combination of the clock control method and the reset control method, the BIOS has to release the reset of the devices and at the same time start supplying a clock to the devices in order to unhide the devices.

Meanwhile, according to the present invention, the common boot sequence of an OS can be intentionally changed by hiding a specific device. For example, according to the common boot sequence, the OS finishes preparations (e.g., the loading of various devices included in the electronic device 100) for using the various devices and then displays a basic screen to a user. According to the present invention, the time when the various devices included in the electronic device 100 are prepared to be used can be intentionally controlled. For example, the drivers for the selected first devices may start being loaded before the OS displays the basic screen to the user, after the OS displays the basic screen to the user, or almost at the same time when the OS displays the basic screen to the user. That is, the boot time felt by a user (i.e., the time taken for the basic screen to be displayed after the user turns on power) can be significantly reduced by properly controlling the time when the drivers for the first devices start being loaded. It is preferred that the time when the drivers for the first devices finish being loaded be after the basic screen is displayed.

If the devices having the loading of their drivers intentionally delayed continue to be hidden or the time for which the devices are hidden is long, however, there may be a problem that the devices may not be normally operated when a user uses the devices.

In order to solve the problem, a scheme for properly controlling the time when the devices are unhidden has to be provided. This problem can be solved by properly designing the above-described predetermined event. The predetermined event is described below.

The predetermined event may be set according to various methods.

For example, the BIOS may designate a specific service or a specific script or both, from among various services or various scripts or both loaded by the OS, so that the loading of the designated service or the designated script or both is set as the predetermined event.

For another example, the BIOS may set a logon event, generated by the OS, as the predetermined event.

For yet another example, the BIOS may set an elapse of some time (e.g., 10 seconds) from a specific reference time (e.g., when the OS first scans the bus) as the predetermined event.

For stilly yet another example, the BIOS may set access, generated based on service or software or both whose execution has been requested by a user for a specific device, as the predetermined event.

Since the predetermined event is set according to the various methods as described above, the electronic device 100 can reduce the boot time by the time taken for drivers for the remaining devices other than essential devices to be loaded. Furthermore, the electronic device 100 can load the drivers for the respective devices at an appropriate time so that the devices can be normally operated when a user actually uses the devices.

According to the first embodiment of the present invention, the device unhiding operation on all the first devices may not be performed at the same time, and the unhiding time may be differently set for the first devices. For example, a USB device may be unhidden at a first time, and an HDMI device may be unhidden at a second time.

The first embodiment of the present invention has the following advantages.

First, there is an advantage in that the boot time felt by a user can be significantly reduced because the device unhiding operation (S107) is controlled so that it is started when a basic screen (e.g., a wallpaper of the MS Windows) for enabling a user to operate an electronic device starts being displayed or after the basic screen is displayed, although not necessarily limited.

Second, it is assumed that the OS of the electronic device is the MS Windows, for convenience of description of the present invention. According to the present invention, however, the BIOS (i.e., firmware) configured to perform an operation related to device hiding (S105) is designed in order to improve the boot speed of the electronic device 100. Accordingly, there is an advantage in that the boot speed can be improved independently from an OS. In other words, there is an advantage in that the boot speed can be significantly improved by merely changing a simple BIOS design without a change of a special design for an OS.

Third, there is an advantage in that the boot time can be reduced irrespective of a type of a device included in an electronic device because the time taken to load drivers for various devices is not included in the boot time felt by a user.

A second embodiment of a method of reducing the boot time of an electronic device according to an aspect of the present invention which may be applied to the electronic device 100 is described in detail below. The second embodiment is described with reference to the electronic device 100 of FIG. 1, for convenience of description, but the method according to the second embodiment of the present invention is not necessarily limited and applied to the electronic device 100 described with reference to FIG. 1.

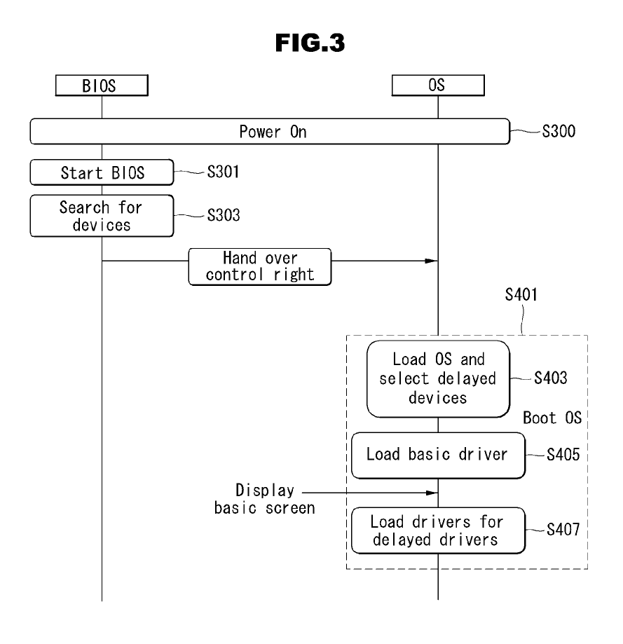

FIG. 3 is a diagram illustrating the second embodiment of the method of reducing the boot time of the electronic device 100 according to an aspect of the present invention.

Referring to FIG. 3, power may start being supplied to the electronic device 100 at step S300.

Next, the electronic device 100 may start the BIOS at step S301.

At this time, the BIOS may search for the various devices 150 that are included in the electronic device 100 or connected to the electronic device 100 as described above at step S303.

In performing the step S303, the BIOS may initialize the retrieved devices (e.g., the supply of power, reset control, and the supply of a clock) and then provide the OS with information about the retrieved devices, unlike in the first embodiment of the present invention.

Next, the OS is loaded into the electronic device 100 at step S403, and thus the control right of the electronic device 100 is handed over from the BIOS to the OS. When the OS is loaded into the electronic device 100 at step S403, the OS may select devices to be loaded with delay from among he retrieved devices 150, at step S403.

The devices to be loaded with delay may be selected by taking information, previously set in the OS, into consideration or may be selected by taking information, provided by the BIOS, into consideration. If the devices to be loaded with delay are selected by taking the information, provided by the BIOS, into consideration, the information about the devices to be loaded with delay may be previously stored in the BIOS. The information may be provided to the OS along with the information about the retrieved devices which is provided by the BIOS at step S303.

Next, the OS may load drivers for basic devices other than the devices to be loaded with delay, from among the retrieved devices 150, at step S405.

The devices to be loaded with delay according to the second embodiment of the present invention may conceptually correspond to the first devices described in connection with the first embodiment of the present invention. The basic devices according to the second embodiment of the present invention may conceptually correspond to the second devices described in connection with the first embodiment of the present invention. Accordingly, a description of a criterion for selecting the devices to be loaded with delay and the basic devices and a conceptual description thereof are omitted.

Next, the OS may load drivers for the devices to be loaded with delay at step S407.

The time when the step S407 is performed may be set similarly to the time when the device unhiding operation described in connection with the first embodiment of the present invention is performed. More particularly, a specific service or a specific script or both may be designated from among various services or various scripts or both loaded by the OS. The time when the designated service or the designated script or both is loaded, the time when a logon event is generated by the OS, the time after an elapse of some time (e.g., 10 seconds) from a specific reference time (e.g., when the OS first scans the bus), or the time when access is generated based on service or software or both whose execution has been requested by a user for a specific device may be set as the time when the step S407 is performed.

The time when the step S407 will be performed is set according to various methods as in the first embodiment of the present invention. Accordingly, the electronic device 100 can reduce the boot time by the time taken for drivers for the remaining devices (i.e., the devices to be loaded with delay) other than the basic devices to be loaded. Furthermore, the electronic device 100 can load the drivers for the devices at an appropriate time so that the devices can be normally operated when a user actually uses the devices.

In the second embodiment of the present invention, however, there is a problem in that a design for the OS has to be changed so that the electronic device 100 can be operated according to the above method. In general, a manufacturer who manufactures and sells the electronic device 100 differs from an OS supplier who designs the OS and provides the OS to the electronic device 100. Accordingly, there is a problem in that the manufacturer of the electronic device, such as a computer, inevitably seeks the support of the OS suppliers in order to manufacture the electronic device according to the second embodiment of the present invention.

In view of the problem, if the BIOS is designed without the active help of the OS supplier so that the electronic device 100 is operated according to the method described in connection with the first embodiment of the present invention, the manufacturer of the electronic device 100 can change a design for the BIOS (i.e., firmware provided to the electronic device 100) alone in order to achieve an intended object.

If the OS supplier sets up a protocol for communication with devices to be loaded with delay along with the BIOS and provides the protocol to the manufacturer of the electronic device 100 (i.e., if a setting value for the devices to be loaded with delay is stored in the BIOS and the OS designs the setting value in the protocol that is necessary for the OS to receive the setting value from the BIOS), however, the electronic device 100 may be designed so that the electronic device is operated according to the method according to the second embodiment of the present invention.

A third embodiment of a method of reducing the boot time of an electronic device according to an aspect of the present invention which may be applied to the electronic device 100 is described in detail below. The third embodiment is described with reference to the electronic device 100 of FIG. 1, for convenience of description.

A function commonly called ‘USB legacy’ is supported by the BIOS. When the USB legacy function is set to ‘Enable’ in the BIOS, the BIOS in itself initializes USB devices so that external devices connected to the USB devices can be used from a booting initial stage before the OS is loaded. If the USB legacy function is set to ‘Disable’, the USB devices are not initialized by the BIOS, but are initialized by the OS. Accordingly, the external devices connected to the USB devices can be used after the OS is loaded.

For example, if a user tries to use the electronic device 100 by selectively connecting an external device to a USB device (e.g., when the electronic device is booted through the OS recorded on an external storage medium connected thereto through the USB device), the user has to directly change the setting of the BIOS.

If the USB legacy function is always set to ‘Enable” by default in order to remove this problem, the total boot time is increased by the time that the BIOS takes to initialize the USB device.

The method of reducing the boot time of the electronic device according to the third embodiment of the present invention has been made to solve the above problem. In the third embodiment of the present invention, the USB legacy function is selectively turned on or off by taking state information about the electronic device into consideration. In this case, there are advantages in that the boot time can be reduced in normal conditions and user inconvenience can also be reduced because USB devices are automatically initialized when a user selectively uses the USB legacy function.

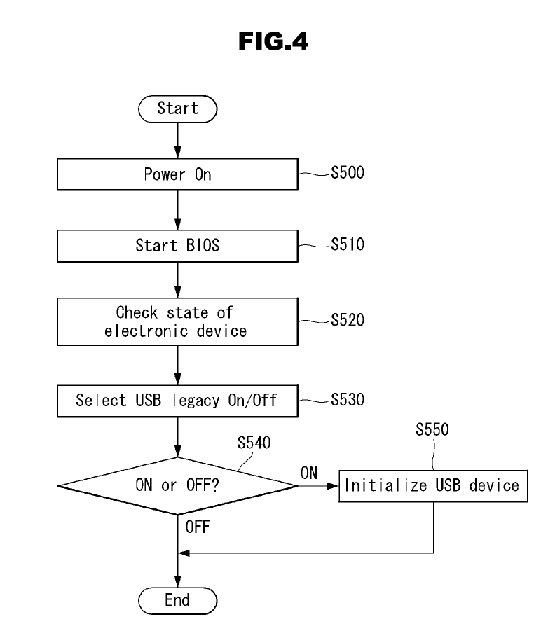

FIG. 4 is a diagram illustrating the third embodiment of the method of reducing the boot time of the electronic device according to an aspect of the present invention.

Referring to FIG. 4, when power is supplied to the electronic device 100 at step S500, the BIOS of the electronic device is started at step S510.

At this time, the BIOS may check the state of the electronic device at step S520.

An embodiment regarding the state of the electronic device to be checked by the BIOS may be very various, but some examples thereof are described in order to help easily understand the present invention.

For example, the BIOS may check whether external electronic devices are connected to the USB devices of the electronic device.

For another example, the BIOS may check whether the booting sequences of USB devices set through the BIOS of the electronic device are given a specific priority or higher. For example, the BIOS may check whether the booting sequences of the USB devices are given the highest priority or whether the booting sequences of the USB devices are given priorities higher than a hard disk drive in which the OS is stored (but the booting sequences of the USB devices are not necessarily given the highest priority). In addition, the BIOS may check other states for the electronic device through which a user's intention to use a USB device can be checked. For example, if a signal being inputted by a user is detected through the keyboard (i.e., one of external devices connected to the electronic device through USB devices), it can be seen that the user has intention of using the USB device.

If a user's intention to use a USB device is checked by taking the state of the electronic device, checked at step S520, into consideration, the BIOS selectively turns on (i.e., enable) the USB legacy function. If the user's intention to use a USB device is not checked, the BIOS selectively turns off (i.e., disable) the USB legacy function at step S530.

Next, the BIOS checks whether the USB legacy function is turned on or off at step S540. If, as a result of the check, the USB legacy function is turned on, the BIOS initializes the USB device at step S550. If, as a result of the check, the USB legacy function is turned off, the BIOS does not initialize the USB device.

As described above, according to other embodiments of the present invention, since the USB legacy function is selectively turned on or off, there are advantages in that the boot time can be reduced in normal situations and user inconvenience can be reduced because a USB device is automatically initialized when a user selectively uses the USB legacy function.

The third embodiment of the present invention discloses the method in which the BIOS may select USB devices by selectively enabling or disabling the USB devices has been disclosed, but not necessarily limited and applied to the USB devices. For example, a person having ordinary skill in the art may easily know that the third embodiment of the present invention may also be applied to devices (e.g., SATA, IDE, and PCI according to the existing interface methods and devices according to other interface methods that may be standardized and provided in the future) other than the USB devices.

The present invention has the following advantages.

First, there is an advantage in that the boot time felt by a user can be significantly reduced because the device unhiding operation (S107) is controlled so that it is started when a basic screen (e.g., a wallpaper of the MS Windows) for enabling a user to operate an electronic device starts being displayed or after the basic screen is displayed, although not necessarily limited.

Second, it is assumed that the OS of an electronic device is the MS Windows, for convenience of description of the present invention. According to the present invention, however, a BIOS (i.e., firmware) configured to perform an operation related to device hiding is designed in order to improve the boot speed of an electronic device. Thus, there is an advantage in that the boot speed can be improved independently from an OS. In other words, there is an advantage in that the boot speed can be significantly improved by merely changing a simple BIOS design without a change of a special design for an OS.

Third, there is an advantage in that the boot time can be reduced irrespective of a type of a device included in an electronic device because the time taken to load drivers for various devices is not included in the boot time felt by a user.

Fourth, there are advantages in that, since the USB legacy function is selectively turned on or off, the boot time can be reduced in normal situations and user inconvenience can be reduced because a USB device is automatically initialized when a user selectively uses the USB legacy function.

The various embodiments disclosed in this document may be implemented individually or in combination. Furthermore, steps forming one embodiment may be combined with steps forming the other embodiment. It means that the first to third embodiments of the present invention ma be combined and implemented.

The various embodiments of this document may be implemented using computer readable medium. The medium may include program codes, data files, and data structure for implementing the embodiment of this document solely or in combination. An example of the medium may include a medium configured to store and execute program commands, such as magnetic media, optical recording media, such as CD and DVD, ROM, RAM, and flash memory. The program codes may include, for example, not only machine codes produced by a compiler, but also high-level language codes executable by a computer using an interpreter.

Those having ordinary skill in the art to which this document pertains may change and modify this document in various ways without departing from the technical spirit of this document. Accordingly, this document is not limited to the above-described embodiments and the accompanying drawings. Furthermore, the embodiments described in this document should not be construed to be limitative from all the aspects, and some of or all the embodiments may be selectively combined in various ways.

1-15. (canceled)

16. A method of controlling booting of an electronic device, the method comprising:
once a booting operation of the electronic device starts, identifying, by the electronic device, at least one first device among a plurality of devices, for loading at least one corresponding driver later, wherein the plurality of devices are provided in the electronic device or are associated with the electronic device;
first loading, by the electronic device, at least one driver corresponding to at least one second device among the plurality of devices while not loading the at least one driver corresponding to the identified at least one first device; and
after the first loading step, second loading the at least one driver corresponding to the identified at least one first device according to a predetermined event.

17. The method of claim 16, further comprising:
hiding, by a BIOS of the electronic device, the identified at least one first device so that the at least one driver corresponding to the identified at least one first device is not loaded during the first loading step.

18. The method of claim 17, wherein the hiding step includes at least one of:
blocking a supply of power to the at least one first device,
blocking a supply of a clock signal to the at least one first device,
maintaining the at least one first device in a reset state, and
providing inaccurate information about the at least one first device to an OS of the electronic device.

19. The method of claim 18, further comprising:
before the second loading step, unhiding the hidden at least one first device by the BIOS,
wherein the unhiding step includes at least one of:
starting the supply of the power to the at least one first device,
starting the supply of the clock signal to the at least one first device,
preparing the at least one first device in a standby state, and
providing accurate information about the at least one first device to the OS.

20. The method of claim 16, wherein the predetermined event comprises at least one of:
a loading of at least one of a predetermined service and a predetermined script through an OS of the electronic device,
a generation of a logon event through the OS,
an elapse of a predetermined time, and
a generation of access to the at least one first device.

21. The method of claim 16, wherein the identifying step is performed by an OS of the electronic device.

22. The method of claim 21, wherein the OS identifies the at least one first device based on information previously set in the OS or based on information provided by a BIOS of the electronic device.

23. The method of claim 21, wherein the OS delays the loading of the at least one driver corresponding to the identified at least one first device until the first loading step is completed.

24. The method of claim 16, further comprising:
allowing a use of the electronic device by a user during the second loading step, or after the first loading step but before a start of the second loading step.

25. An electronic device comprising:
at least one storage unit configured to store therein a BIOS and an OS; and
a controller configured to control a booting operation of the electronic device using at least one of the BIOS and the OS by:
once the booting operation of the electronic device starts, identifying at least one first device among a plurality of devices, for loading at least one corresponding driver later, wherein the plurality of devices are provided in the electronic device or are associated with the electronic device;
first loading at least one driver corresponding to at least one second device among the plurality of devices while not loading the at least one driver corresponding to the identified at least one first device; and
after the first loading step, second loading the at least one driver corresponding to the identified at least one first device according to a predetermined event.

26. The electronic device of claim 25, wherein under control of the controller, the BIOS hides the identified at least one first device so that the at least one driver corresponding to the identified at least one first device is not loaded during the first loading step.

27. The electronic device of claim 26, wherein the BIOS hides the identified at least one first device, by performing at least one of:
blocking a supply of power to the at least one first device,
blocking a supply of a clock signal to the at least one first device,
maintaining the at least one first device in a reset state, and
providing inaccurate information about the at least one first device to the OS.

28. The electronic device of claim 27, wherein the BIOS is further configured to unhide the hidden at least one first device before the second loading step, by performing at least one of:
starting the supply of the power to the at least one first device,
starting the supply of the clock signal to the at least one first device,
preparing the at least one first device in a standby state, and
providing accurate information about the at least one first device to the OS.

29. The electronic device of claim 25, wherein the predetermined event comprises at least one of:
a loading of at least one of a predetermined service and a predetermined script through the OS,
a generation of a logon event through the OS,
an elapse of a predetermined time, and
a generation of access to the at least one first device.

30. The electronic device of claim 25, wherein under control of the controller, the OS identifies the at least one first device among the plurality of devices.

31. The electronic device of claim 30, wherein the OS identifies the at least one first device based on information previously set in the OS or based on information provided by the BIOS.

32. The electronic device of claim 30, wherein the OS delays the loading of the at least one driver corresponding to the identified at least one first device until the first loading step is completed.

33. The electronic device of claim 25, wherein the controller allows a use of the electronic device by a user during the second loading step, or after the first loading step but before a start of the second loading step.

34. A method of controlling booting of an electronic device, the method comprising:
starting a booting operation of the electronic device by starting a BIOS of the electronic device;
checking a state of the electronic device by the BIOS;
determining, by the BIOS, whether to turn on or off a USB legacy function for the electronic device based on a result of the checking step; and
selectively turning on the USB legacy function during the booting operation of the electronic device based on a result of the determining step.

35. The method of claim 34, wherein the checking step checks a booting priority of at least one USB device associated with the USB legacy function of the electronic device.
